(19) United States
(12) Patent Application Publication
(10) Pub. No.: US 2025/0248558 A1
(43) Pub. Date: Aug. 7, 2025

(54) BEVERAGE PREPARATION SYSTEM

(71) Applicant: SOCIETE DES PRODUITS NESTLE S.A., Vevey (CH)

(72) Inventors: ARMIN GEMPERLE, Wil SG (CH); ANDREAS STRAUMANN, Elgg (CH); SILVIA QUATTRONE, Lausanne (CH); ARAMIA ASMAR, Yverdone-les-bains (CH); FREDERIC FRAGNIERE, Orbe (CH)

(21) Appl. No.: 18/856,283

(22) PCT Filed: Apr. 6, 2023
(86) PCT No.: PCT/EP2023/059157

§ 371 Date: Oct. 11, 2024

(30) Foreign Application Priority Data
Apr. 14, 2022 (EP) 22168478.0

(51) Int. Cl. A47J 31/36; A47J 31/46

(52) U.S. Cl. CPC A47J 31/3676; A47J 31/461; A47J 31/468

(57) ABSTRACT

The invention concerns a machine for preparing beverages from at least two different types of containers, said machine comprising: —a first extraction device (1) and a second extraction device (1) configured to prepare beverages from different types of containers, wherein the first extraction device is a motorised extraction device actuated by a motor (121) during the preparation of a beverage from the first type of container, —a fluid supply system (3), said system comprising at least a fluid source (31), a pumping means (32), a heating and/or cooling means (33) and a valve (4) configured for supplying the fluid either to the first extraction device (1) through a first outlet (422a) or to the second extraction device (2) through a second outlet (422b).

### FIELD OF THE INVENTION

The present invention relates to a beverage system configured to prepare beverages from different types of containers.

### BACKGROUND OF THE INVENTION

WO 2019/096830 describes a beverage preparation machine for the preparation of beverage from two different types of containers: pods for the preparation of coffee from roast and ground coffee and sachets for the preparation of milk from milk powder. This machine requires at least two motors to actuate the extraction device of the different containers, precisely the motor to enclose the pod of roast and ground coffee in the brewing chamber and the motor to introduce the needle in the sachet.

The cost of manufacturing of this machine is high due to the presence of these two motors and the need for a three-way valve to control the supply of water either to the pod or to the sachet. The cost of use is increased too.

There is a need to reduce the costs of such a machine extracting beverage from different types of containers.

An object of the invention is to address this problem.

Objects of the invention are achieved by the machine for preparing beverages according to Claim 1.

### SUMMARY OF THE INVENTION

In the invention, there is provided a machine for preparing beverages from at least two different types of containers, said machine comprising:
a first extraction device and a second extraction device, said devices being of different types and being configured to prepare a beverage from one respective first type and second type of container, wherein the first extraction device is a motorised extraction device actuated by a motor during the preparation of a beverage from the first type of container,
a fluid supply system, said system comprising at least a fluid source, a pumping means, a heating and/or cooling means and a valve configured for supplying the fluid either to the first extraction device through a first outlet or to the second extraction device through a second outlet,
wherein the valve comprises a movable part configured to dispense the fluid through said first outlet or through said second outlet depending on the position of said movable part, and
wherein the movable part of the valve is indirectly actuated by the motor of the motorised extraction device, when said motor actuates the motorised extraction device for the preparation of a beverage by said extraction device and is moved to a position where the fluid is dispensed through the first outlet, and
wherein, at rest, the movable part is positioned so that the fluid is dispensed through the second outlet.

Accordingly, the machine comprises one motor only for the first extraction device and this motor provides the effect of positioning the valve to the first extraction device when the motor actuates the first extraction device for a beverage preparation.

### BRIEF DESCRIPTION OF THE DRAWINGS

Specific embodiments of the invention are now described further, by way of example, with reference to the following drawings in which:

FIG. 1 is a view of a beverage machine according to the invention

FIG. 2 is an isolated view of the two extraction units of the beverage preparation machine of FIG. 1,

FIG. 3A illustrates a pack used as a first type of container,

FIG. 3B illustrates the fluid processing device of a first extraction unit using the pack,

FIG. 4A illustrates a pod used as a second type of container,

FIGS. 4B and 4C illustrate the pod enclosing parts of the second extraction unit using the pod,

FIGS. 4D and 4E illustrate the relative positions of the two enclosing parts of the second extraction unit,

FIG. 5 corresponds to FIG. 2 in which the core parts of the extraction units were isolated and the fluid supply system 3 was schematically illustrated,

FIG. 6A is a perspective view of the valve of the machine of FIG. 2 and FIG. 6B is a cross section view of this valve,

FIG. 6C is a perspective view of the connection of the motor and the valve.

FIG. 7A is a perspective view of an alternative valve and FIG. 7B is a cross section view of this valve.

### DETAILED DESCRIPTION OF EXEMPLARY EMBODIMENTS

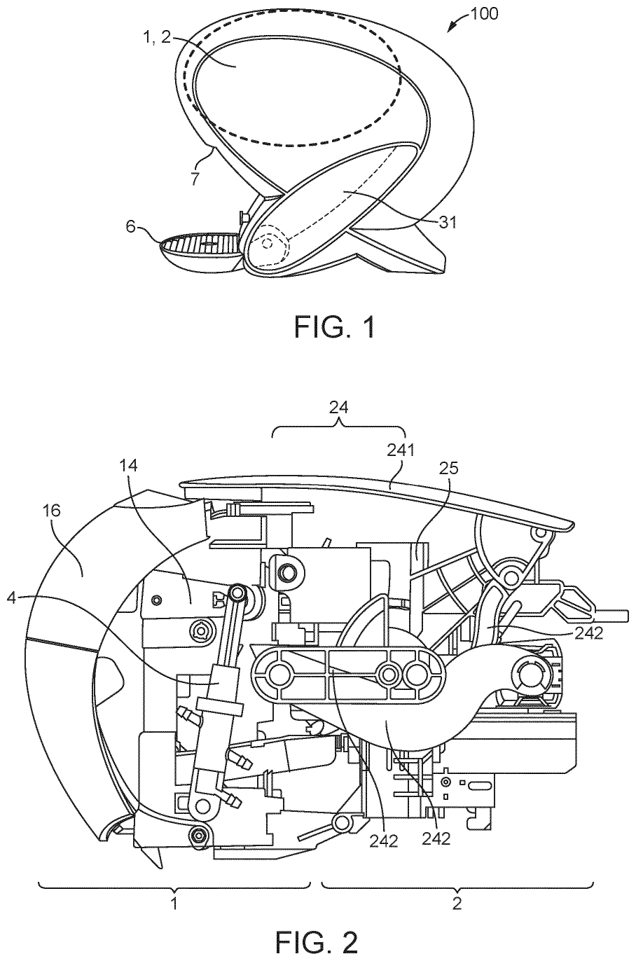

FIG. 1 illustrates a beverage machine 100 according to the invention. The machine comprises a cup holder 6 to place a drinking cup and so that a beverage can be dispensed inside the cup from the beverage outlet 7. The beverage is prepared from two extraction units hold inside the machine and covered by the external housing

In FIG. 2, the housing of the machine of FIG. 1 was removed and the two extractions units were isolated from the rest of the machine.

The first extraction unit 1 enables the preparation of a first beverage from a pack as described below. Preferably, this first extraction unit is configured to prepare a milk-based beverage, like milk or foamed milk or a beverage issued from the dissolution of a soluble beverage ingredient like chocolate or soluble instant coffee.

The second extraction unit 2 enables the preparation of a second beverage from a pod as described below. Preferably, this second extraction unit is configured to prepare a coffee-based beverage, in particular from roast and ground coffee.

The pack and the pod are two different containers containing pre-portioned beverage ingredients. The ingredients are pre-portioned as a single-serving (e.g. enough for a single beverage to be produced therefrom). The container may have a maximum capacity such that it can only contain said single-serving of precursor material. The container may be single use, e.g. it is physically altered after a preparation process, which can include one or more of: perforation to supply fluid to the beverage ingredient, perforation to supply the beverage from the container, opening by a user to extract the beverage ingredient.

The two beverages are dispensed at the cup holder position. This machine enables the preparation of a final beverage consisting of either the first or the second beverage or a final beverage that is a mixture of the first and second beverages like a cappuccino or latte macchiato.

The first extraction unit 1 comprises an openable door 16 to introduce the pack in the machine.

The second extraction unit 2 comprises an actuating device 24 which is a handle 241 attached to interrelated knee levers 242 to enable the movement of sub-parts of said unit as described below.

The machine comprises a valve 4 attached to one part of the chassis of the machine, here to the chassis part 14 of the first extraction unit.

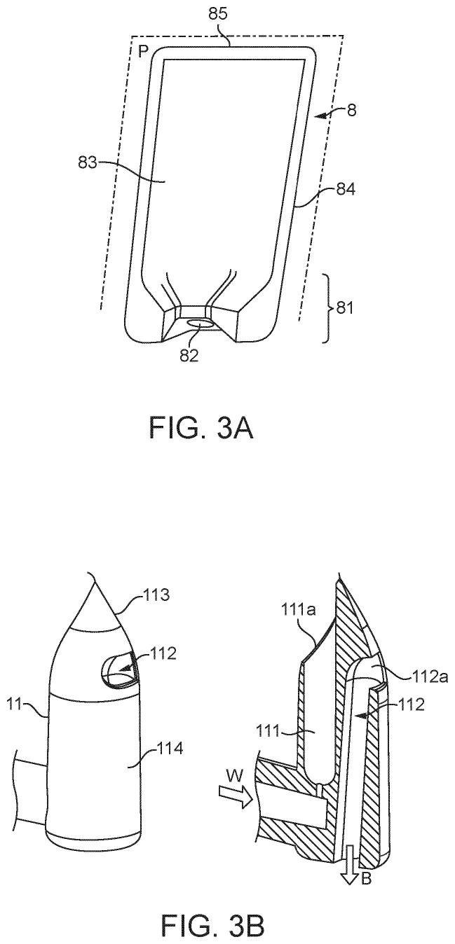

FIG. 3A is a perspective view of a pack 8 that can be used as a first type of container in the first extraction unit 1.

This pack comprises an ingredient that is configured to be mixed with a fluid to produce a beverage. The pack presents a plane shape oriented along a plane P. Two longitudinal plane walls 83 (front and back) extends along this plane P.

In this specific embodiment, the walls are made of a flexible material and the lateral edges 84 of these walls are sealed, as well as the edges at the top end 85. The bottom side 81 comprises an area 82 that is an openable area. This openable area 82 can be a hole covered by a pierceable cover or membrane. This openable area 82 is adapted to enable the introduction of the fluid processing device 11 of FIG. 3B so that said device protrudes inside the internal volume of the pack in order to introduce the fluid and to collect and dispense the beverage.

Such pack can correspond to the pack described in WO 2022/023578 or WO 2022/022901.

FIG. 3B is a perspective view and a cross section view of the fluid processing device 11 of a first extraction unit using the pack 8.

The body of this device 11 comprises a body 114, that is preferably essentially cylindrical, and an upwardly pointed end 113, which preferably presents a conical shape extending from the body 114.

This body comprises:
an internal inlet conduit 111 for driving a fluid, preferably water, to the pointed end 113, as illustrated by the arrow W, and
an internal outlet conduit 112 for driving the prepared beverage from the internal volume of the pack in a downward direction as illustrated by arrow B.

By internal it is meant that these conduits extend inside the body and not along the surface of the body. Consequently, when the fluid processing device is introduced in a pack, liquids flow in and out of the pack through these internal conduits which provide a better guidance.

These both conduits are distinct one from the other. Each conduit 111, resp. 112 presents an end 111a, resp. 112a that emerges at the upper part of the body.

Preferably, the end 111a of the inlet conduit is designed so as to orientate a jet a fluid upwardly inside the pack.

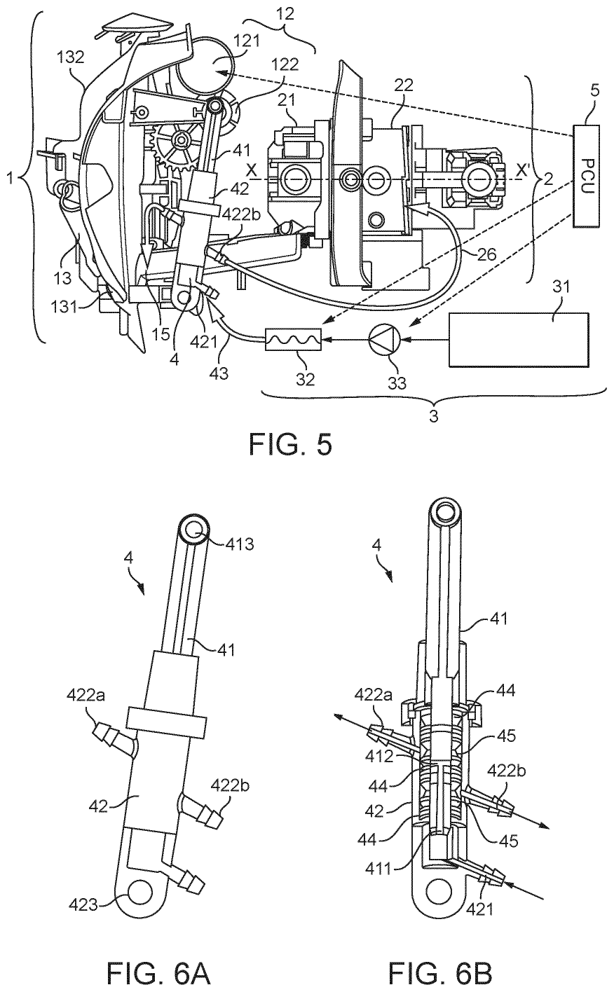

An actuating device 12 (FIG. 5) is adapted to move this fluid processing device 11 to the pack 8 hold in a pack chamber 13 (FIG. 5) of the first extraction unit and, in particular the pointed part 113 to the openable area 82 in order to open the openable area 82 or any membrane or cover provided at this area. In an alternative embodiment, the actuating device 12 can be adapted to move the pack 8 to the fluid processing device 11 to obtain the same effect.

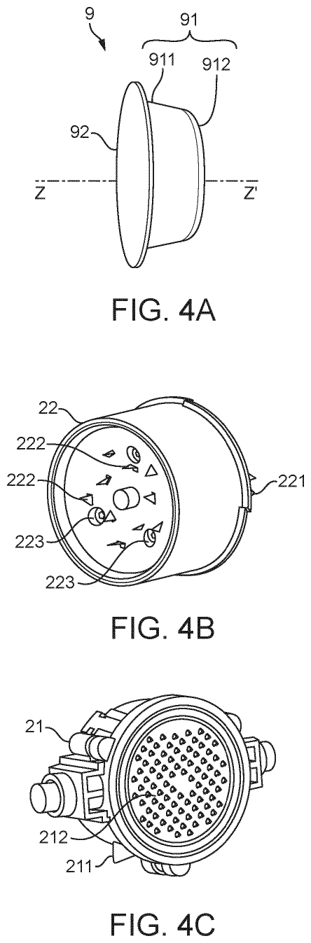

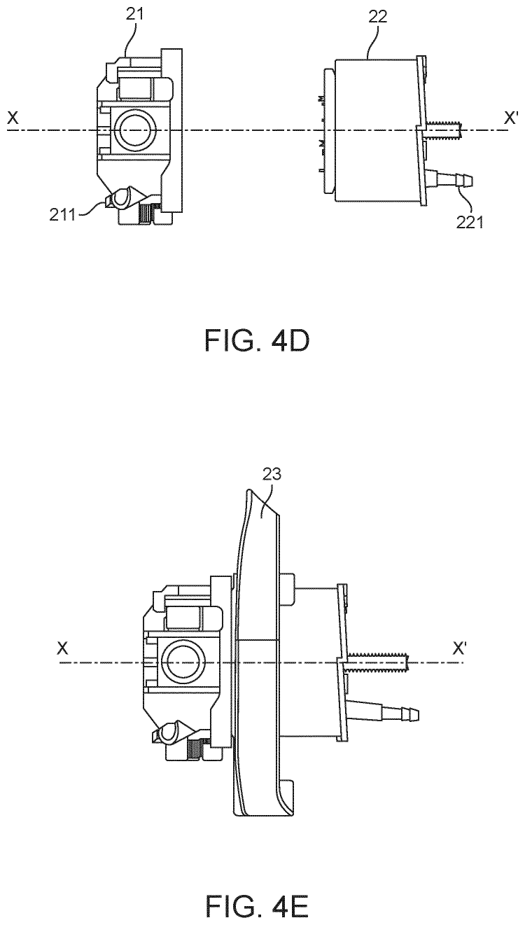

FIG. 4A illustrates a pod 9 used as a second type of container in the second extraction unit of the machine 100.

The pod 9 comprises a pod body 91 with one sidewall 911 that extends axially from a bottom wall 912 towards a top. Generally, any transversal cross section of the body is circular from the bottom to the top and the flange is circular too. The body delimits a chamber for containing a beverage ingredient.

This beverage ingredient is preferably an ingredient able to be extracted with water like roast and ground coffee. In a less preferred manner, the beverage ingredient can be tea leaves or a water soluble powder ingredient such as: instant coffee powder, milk powder, cream powder, instant tea powder, cocoa powder, soup powder, fruit powder or mixture of said powders or even a soluble liquid ingredient or a beverage concentrate such as a syrup or milk concentrate. The powders can be agglomerated or sintered.

The pod comprises a lid 92 that is fixed, sealed or attached to a circumferential flange of the top of the pod body and accordingly covers and closes the top opening of the body.

The bottom wall 912 is adapted to be pierced so that liquid can be injected in the pod through the pierced openings.

The lid 92 is adapted to be opened by relative engagement with a piercing arrangement under the effect of the liquid pressure increase inside the pod during injection of liquid.

The pod shape is symmetric relatively to the central axial axis ZZ′ extending from the bottom wall to the lid and the pod shape is asymmetrical relatively to the plane of the lid and the flange.

During extraction, the pod is configured to be enclosed between two pod enclosing parts of the second extraction device. This second extraction device comprising upstream and downstream pod enclosing parts relatively movable, preferably translatable, along a longitudinal axis (XX′) between an open position for inserting and removing the pod and a closed position for forming an extraction chamber enclosing the pod during extraction.

FIGS. 4B and 4C are perspective isolated views of the two pod enclosing parts 21, 22 of the second extraction unit using the pod 9.

The upstream part 22 defines a cage or cavity for enclosing the pod body. The end wall 221 of the cage bears piercing elements 222 for opening the bottom wall of the pod body and liquid outlet openings 223 for supplying liquid into the pod through the holes opened in the bottom wall of the pod. These piercing elements can comprise piercers in the form of blades. These blades can be designed and positioned to pierce the wall of the bottom of the pod body when the upstream and downstream pod enclosing parts are brought to the closed position. The liquid outlet openings 223 can form a shower at the front face of the end wall of the cage and the supplied liquid can be introduced in the pod through the pre-pierced openings.

The downstream part 21 comprises a plate that bears a piercing arrangement 212 for opening the lid of the pod. Usually, this downstream plane piercing arrangement 212 is circular like the lid of the pod. A beverage outlet 211 is provided to dispense the beverage.

Opening happens by relative engagement of piercing arrangement with the lid under the effect of the rise in pressure of the injected liquid in the pod body chamber. This downstream piercing arrangement may comprise a rigid plate comprising opening elements such as spikes, that can present the shape of cones or pyramids, optionally truncated at their ends, on its surface turned to the lid. In addition, the plate comprises traversing holes to evacuate the beverage dispensed from the opened lid to a beverage outlet 211, such as a tube or nozzle collecting and dispensing beverage to a drinking cup.

FIGS. 4D and 4E are side views of the two enclosing parts 21, 22 illustrating the relative movement of these parts between the open position for inserting and removing the pod (FIG. 4D) and the closed position for forming an extraction chamber enclosing the pod during extraction (FIG. 4E). The enclosing parts 21, 22 are relatively translatable along a longitudinal axis XX′. Usually, this axis XX′ is essentially horizontal inside the machine 100. In FIG. 4E, these two parts are in the closed position configured to extract the pod. These two enclosing parts 21, 22 are supported by a chassis 25 of the second extraction unit and made movable between the two positions by actuating the handle 241 connected to these enclosing parts by a system 242 of interrelated knee levers. Accordingly, this second extraction unit is actuated manually.

As shown in FIG. 4E, this second extraction unit 2 comprises a pod holder 23 to receive and hold the pod 9 between the two enclosing parts.

FIG. 5 corresponds to FIG. 2 in which the core parts of the extraction units were isolated and the fluid supply system 3 was schematically illustrated.

This fluid system 3 usually comprises a tank 31 of fluid, generally water, a pump 33 to pump that fluid form the tank and at least one device to adapt the temperature of the fluid like a heater 32 and/or a cooler before the fluid is supplied to the extractions units via the valve 4. The heater 32 is connected by a fluid supply tube 43 with the fluid inlet 421 of the valve. The valve comprises two fluid outlets, configured for dispensing the fluid to:
the first extraction unit 1 by connecting its first outlet 422a with a fluid supply tube 15 of said first unit. The other end of this fluid supply tube 15 connected with the fluid processing device.
or
the second extraction unit 2 by connecting its second outlet 422b with a fluid supply tube 26 of said second unit. The other end of this fluid supply tube 26 is connected with the fluid inlet 221 of the upstream enclosing part

A process control unit 5 of the beverage machine is configured to control the pump 33, the heater 32, and optionally the motor 121 of the first extraction unit, once a beverage is ordered.

This unit 5 can be used to control other controllable devices like the recognition device 7 or a display if present.

In FIG. 5, the door 16 and the housing of the first extraction unit were removed making apparent the pack chamber 13 configured to receive and hold the pack 8 during the beverage preparation and its pack inlet 132 through which the pack is introduced. The pack chamber presents a bottom opening 131 that is configured to enable the interaction between the fluid processing device 11 and the openable area 82 of the pack. This unit 1 comprises an actuating device 12 configured to move the processing device 11 relatively to the pack 8 in order to pierce the openable area and prepare the beverage. In this illustrated embodiment, this actuating device comprises a motor 121 configured to rotate interconnected gear wheels 122 linked to the processing device 11.

This first extraction unit 1 can be similar to the unit described in WO2021/110654, WO2021/110650 and/or WO2021/110652.

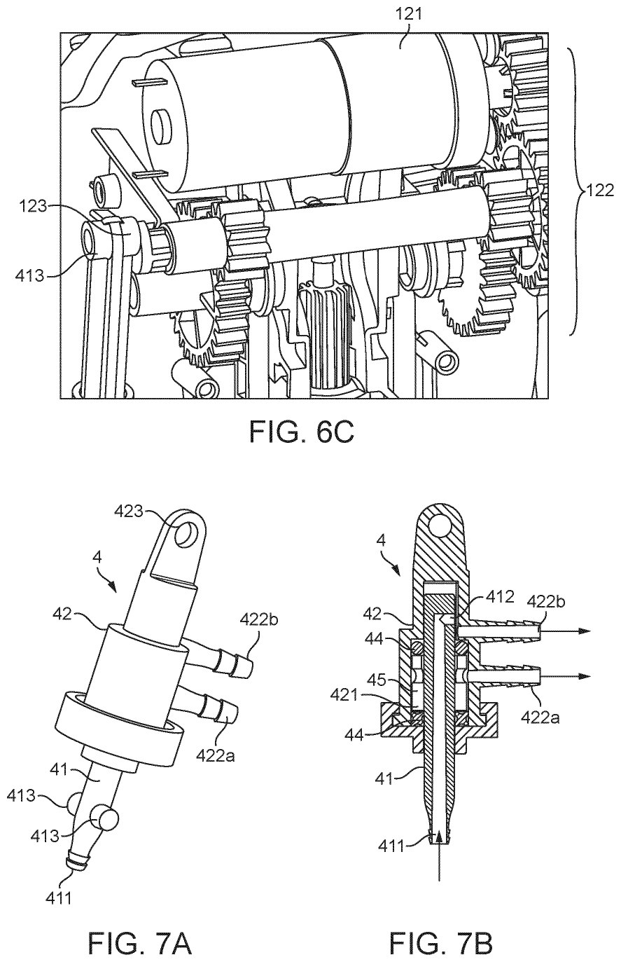

FIGS. 6A and 6B are perspective and cross section views respectively of the valve 4 of the machine of FIG. 5. This valve 4 comprises two tubes 41, 42 one being positioned and slidable inside the other one.

The external distributing tube 42 comprises a fluid inlet 421, the first outlet 422a connectable to the first unit 1 through the tube 15 and the second outlet 422b connectable to the second unit 2 through the tube 26.

The internal connecting tube 41 comprises a fluid inlet 411 and a fluid outlet 412. It is positioned inside the external distributing fluid 42 so that the fluid inlets 411, 421 are positioned aside. The fluid inlet of the distributing tube surrounds the the fluid inlet of the inlet tube.

In this illustrated embodiment, the external tube 42 is fixed and attached to the frame of the second extraction unit by its end 423.

The internal connecting tube 41 is able to slide inside the external distributing tube 42 and to be stopped in at least two different positions:
one first position where its fluid outlet 412 is connected with the first outlet 422a of the external distributing tube and consequently is able to supply fluid to the first extraction unit 1 for the preparation of a beverage from the pack 8, and
one second position where its fluid outlet 412 is connected with the second outlet 422b of the external distributing tube and consequently is able to supply fluid to the second extraction unit 2 for the preparation of a beverage from the pod 9.

The movable tube of the valve is indirectly actuated by the motor 121 of the first extraction unit, when said motor moves the fluid processing device 11 for the preparation of a beverage from a pack 8. As illustrated in FIG. 6C, one free end 123 of the internal connecting tube is attached by a connecting rod 123 to one gear wheel 122 rotated by the motor 121 which produce a translation of the movable tube inside the external distributing tube when the motor actuates the gear wheel 122 in order to move the fluid processing device 11.

The positions of the internal connecting tube 41 are pre-determined so that:
by default, the internal connecting tube 41 is on the second position and is able to dispense the fluid from the fluid supply system 3 to the second extraction unit 2.
if a beverage is prepared from a pack 8 in the first extraction unit 1, the internal connecting tube 41 is moved to the first position when the fluid processing device 11 is introduced in the pack. Then, the process control unit 5 can actuate the pump 32 to dispense fluid to the pack. Accordingly, the valve is oriented in the machine and the first and second outlets 422a, 422b of the external distributing tube are positioned in the valve so that the movement of the motor and the gear wheel to enable the movement the fluid processing device 11 is configured to displace simultaneously the fluid outlet 412 of the internal connecting tube from the second outlet 422b of the external distributing tube to the first outlet 422a.

Preferably the clave 4 comprises seals 44 to get tightness and inserts 45 to retain the position of theses seals.

FIGS. 7A, 7B are perspective and cross-section views of an alternative valve 4. In this alternative, the internal connecting tube 41 is fixed, its end 413 being attached to the chassis of the first extraction unit, and the external distributing tube 42 is slidable around the internal tube, its end 423 being attached to a gear wheel by a connecting rod.

In the present application:
the term “pod” is used to broadly designate any kind of single-dose container suitable for preparing beverages or other edible products such as capsules, cartridges, portioned or individual packages without limitation to the shape of this container, the material this container is made of or the types of piercing means needed to extract the beverage therefrom.
the term “longitudinally” refers to the orientation of the two enclosing parts one to the other and their movement along the longitudinal axis XX′.
the terms “upstream” and “downstream” refer to the path of liquid through the extraction device from the upstream enclosing part to the downstream enclosing part.

Generally, these terms are used to describe the relational positioning of features of the extraction device. These terms should be understood to refer to said device in its normal orientation when positioned in a beverage machine for the production of a beverage as shown in the FIGS. 1, 2, 5.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification.

As used in this specification, the words “comprises”, “comprising”, and similar words, are not to be interpreted in an exclusive or exhaustive sense. In other words, they are intended to mean “including, but not limited to”.

### LIST OF REFERENCES IN THE DRAWINGS

| | |
|---|---|
| beverage machine | 100 |
| pack extraction unit | 1 |
| fluid processing device | 11 |
| inlet conduit | 111 |
| inlet conduit end | 111a |
| outlet conduit | 112 |
| outlet conduit end | 112a |
| body pointed end | 113 |
| body cylindrical part | 114 |
| actuating device | 12 |
| motor | 121 |
| gear wheels | 122 |
| connecting rod | 123 |
| pack chamber | 13 |
| bottom opening | 131 |
| pack inlet | 132 |
| chassis | 14 |
| fluid supply tube | 15 |
| door | 16 |
| pod extraction unit | 2 |
| downstream enclosing part | 21 |
| beverage outlet | 211 |
| piercing arrangement | 212 |
| upstream enclosing part | 22 |
| fluid inlet | 221 |
| piercing elements | 222 |
| liquid outlet openings | 223 |
| pod holder | 23 |
| actuating device | 24 |
| handle | 241 |
| interrelated knee levers | 242 |
| chassis | 25 |
| fluid supply tube | 26 |
| fluid supply system | 3 |
| fluid source | 31 |
| pumping means | 32 |
| heating and/or cooling means | 33 |
| valve | 4 |
| internal connecting tube | 41 |
| fluid inlet | 411 |
| fluid outlet | 412 |
| end | 413 |
| external distributing tube | 42 |
| fluid inlet | 421 |
| first outlet | 422a |
| second outlet | 422b |
| end | 423 |
| fluid supply tube | 43 |
| seals | 44 |
| inserts | 45 |
| process control unit | 5 |
| cup holder | 6 |
| beverage outlet | 7 |
| pack | 8 |
| bottom side | 81 |
| openable area | 82 |
| longitudinal plane wall | 83 |
| lateral sealed edge | 84 |
| top end | 85 |
| pod | 9 |
| body | 91 |
| sidewall | 911 |
| bottom wall | 912 |
| lid | 92 |

1. Machine for preparing beverages from at least two different types of containers, said machine comprising:
a first extraction device for extracting a first beverage by supplying an extraction liquid into a first type of pre-portioned single-serving container comprising a first beverage ingredient and a second extraction device for extracting a second beverage by supplying an extraction liquid into a second type of pre-portioned single-serving container comprising a second beverage ingredient,
said devices being of different types, wherein the first extraction device is a motorised extraction device actuated by a motor during the preparation of a first beverage from the first type of container,
a fluid supply system, said system comprising at least a fluid source, a pumping means, a heating and/or cooling means and a valve configured for supplying the fluid either to the first extraction device through a first outlet or to the second extraction device through a second outlet,
wherein the valve comprises a movable part configured to dispense the fluid through said first outlet or through said second outlet depending on the position of said movable part, and
the movable part of the valve is indirectly actuated by the motor of the motorised extraction device, when said motor actuates the motorised extraction device for the preparation of a beverage by said extraction device and is moved to a position where the fluid is dispensed through the first outlet, and
wherein, at rest, the movable part is positioned so that the fluid is dispensed through the second outlet.

2. Machine according to claim 1, wherein the valve comprises:
an internal connecting tube comprising a fluid inlet and a fluid outlet, and
an external distributing tube comprising a fluid inlet and the first outlet and the second outlet, and
the internal connecting tube is positioned inside the external distributing tube,
one of said tubes is relatively movable to the other so that the internal connecting tube is able to slide inside the external distributing tube and to connect the fluid outlet of said inlet tube either to the first outlet or the second outlet of the external distributing tube,
the movable tube of the valve is indirectly actuated by the motor of the motorised extraction device, when said motor actuates the motorised extraction device for the preparation of a beverage by said extraction device and is moved to a position where the fluid outlet of the internal connecting tube is connected with the first outlet of the external distributing tube, and
wherein, at rest, the movable tube is positioned so that the fluid outlet of the internal connecting tube is connected with the second outlet of the external distributing tube.

3. Machine according to claim 1, wherein in the valve, the external distributing tube is fixed and the internal connecting tube is slidable inside the distributing tube.

4. Machine according to claim 1, wherein, in the valve, the internal connecting tube is fixed and the external distributing tube is slidable around the inlet tube.

5. Machine according to claim 1, wherein the first extraction device is configured to prepare a beverage from a pack, said pack comprising a beverage ingredient, said pack comprising a bottom side, and said bottom side of said pack comprising an area configured for being openable, and
wherein said first extraction device comprises a fluid processing device comprising a body, said body comprising:
an upwardly pointed end, and
at least one internal inlet conduit for introducing a fluid into said pack for the preparation of a beverage by mixing said fluid with an ingredient contained in said pack,
and
wherein the motor of the actuating device of said first extraction device is configured to move said fluid processing device and said pack one to the other so that the upwardly pointed end opens the openable area of the bottom side of said pack, and to position said fluid processing device and said pack one to the other in an operative position, wherein, in said operative position, the part of said fluid processing device comprising the pointed end protrudes inside the internal volume of the pack in order to introduce the fluid from the inlet conduit end.

6. Machine according to claim 1, wherein the fluid processing device comprises at least one internal outlet conduit for dispensing said beverage from said pack, and
the motor of the actuating device of said first extraction device is configured to move said fluid processing device and said pack one to the other so that, in the operative position, the part of said fluid processing device comprising the pointed end protrudes inside the internal volume of the pack in order to introduce the fluid from the inlet conduit end and to dispense the beverage through the outlet conduit end.

7. Machine according to claim 2, wherein the actuating device comprises gear wheels connecting a shaft of the motor with the fluid processing device and wherein one end of the movable tube of the valve is attached by a connecting rod to one of the gear wheels of this actuating device.

8. Machine according to claim 7, wherein the valve is oriented so that the movement of the motor and the gear wheels to move the fluid processing device is sufficient to displace and position the movable tube so that the fluid outlet of the internal connecting tube is connected with the first outlet of the external distributing tube.

9. Machine according to claim 1, wherein the second extraction device is configured to prepare a beverage from a pod, said pod comprising a pod body and a top lid closing the top opening of the pod body, and
said second extraction device comprising upstream and downstream pod enclosing parts relatively movable along a longitudinal axis between an open position for inserting and removing the pod and a closed position for forming an extraction chamber enclosing the pod during extraction.

10. Machine according to claim 9, wherein the upstream and downstream pod enclosing parts are moved by a manually operated actuating device.
